(19) United States
(12) Patent Application Publication
(10) Pub. No.: US 2007/0217002 A1
(43) Pub. Date: Sep. 20, 2007

(54) Screen synthesizing device

(76) Inventor: Tetsu Fukue, Kanagawa (JP)

Correspondence Address: MCDERMOTT WILL & EMERY LLP, 600 13TH STREET, NW, WASHINGTON, DC, 20005-3096, US

(21) Appl. No.: 11/716,040

(22) Filed: Mar. 9, 2007

(30) Foreign Application Priority Data
Mar. 9, 2006 (JP) P. 2006-064502

(51) Int. Cl. G03B 21/56

(52) U.S. Cl. 359/443

(57) ABSTRACT

A screen synthesizing device includes: a display screen storing part for storing an image of a display screen; a layer reading control part for deciding whether or not a lower layer is transferred, deciding the validity and invalidity of a plurality of layers on the basis of a lower layer transfer deciding flag set by a decided result and parameters of a plurality of layers and controlling only valid layers to be read from a layer storing unit in accordance with the decision; and a synthesizing and calculating part for performing a synthesizing and calculating process only by the valid layers on the basis of a valid layer flag to update the image of the display screen stored in the display screen storing part.

### BACKGROUND OF THE INVENTION

The present invention relates to a screen synthesizing decide for laminating a plurality of layers to synthesize a display screen in accordance with a designated transmittance.

The screen synthesizing device for forming one display screen by laminating a plurality of layers is an indispensable device to display an image. The screen synthesizing device forms the display screen having a plurality of layers laminated on the basis of the designated transmittance.

FIG. 10 is a diagram showing an inner structure of a usual screen synthesizing device. The screen synthesizing device includes a layer reading part 201 for reading layer data from a layer accumulating device (an illustration is omitted), a synthesizing and calculating part 202 for performing a translucent synthesizing calculation and a display screen image storing part 203 for storing a synthesized result.

FIG. 11 is a diagram for explaining the state of a screen display by the usual screen synthesizing device. Here, layers have a size not larger than the size of a display screen and rectangular screen images of free sizes and forms and respectively have designated transmittance. The screen synthesizing device scans from the upper part to the lower part of the display screen and performs a synthesizing calculation of the plurality of layers for each line of the display screen in the synthesizing and calculating part 202.

As one example, a synthesizing process of an mth line of the display screen will be described. Here, a layer 0 is located in a lowermost position and a layer 3 is located in an uppermost position. A layer 2 has a translucent screen image, however, the layer 0, a layer 1 and the layer 3 have the transmittance of 0. Thus, the layer 2 is a completely overwritten layer without penetrating the lower layers.

A synthesizing and calculating part 52 of the screen synthesizing device synthesizes in order the lower layers of the layers located in the mth lines. Since the lowermost layer is the layer 0, the layer reading part 201 reads image data corresponding to the mth line of the layer 0 from the layer accumulating device (the illustration is omitted) and stores the image data in a prescribed area of the display screen image storing part 203 in accordance with a display position preset in the layer 0. Then, the layer reading part 201 likewise reads image data corresponding to the mth line of the layer 1 from the layer accumulating device and stores the image data in a prescribed position of the display screen image storing part 203 in accordance with a display position preset in the layer 1. At that time, pixel data of the layer 0 that is already stored in the prescribed area of the display screen image storing part 203 is read to store the synthesized and calculated result of the pixels of the layer 0 and the layer 1 in the prescribed area of the display screen image storing part 203 in accordance with a transmittance α₁ (in this case, α₁=0) given to the layer 1.

The above-described processes are sequentially carried out to the layer 2 and the layer 3. In the synthesizing calculation of the layer 2, the translucent synthesizing calculation of the pixels of the layers 0 and 1 and the layer 2 is performed. In accordance with the above-described procedure, the screen composed of the layers 0 to 3 is synthesized. In such a way, when the layer n+1 having the transmittance αₙ₊₁ is synthesized, the results of the translucent synthesizing calculation of screen images 0 to n are already stored in the display screen image storing part 203. Accordingly, the layer n+1 and the results of the translucent synthesized calculation of the layers 0 to n are synthesized, so that the translucent synthesizing process of the plurality of layers are recursively performed. When the transmittance of the layer n+1 is αₙ₊₁=0 the layer is completely overwritten, so that the synthesized results of the layers 0 to n are not reflected on a final display screen image.

Patent Document 1 Japanese Patent No. 3380859

When an area is generated in which the lower layer is hidden by overwriting the layer, the area is not reflected on the display screen image. Accordingly, the lower layer data does not need to be originally read from the layer accumulating device. Ordinarily, since the layer accumulating device is composed of a memory unit such as an SDRAM and is a common accumulating device in which accesses from other units such as a CPU frequently arise, when the accesses are crowded, the performance of an entire system is deteriorated. Accordingly, unnecessary accesses (reading) are preferably reduced as much as possible.

### SUMMARY OF THE INVENTION

It is an object of the present invention to provide a screen synthesizing device that can reduce unnecessary accesses to a layer accumulating device to improve the performance of an entire system.

A screen synthesizing device of the present invention comprises; a display screen storing unit for storing an image of a display screen; a lower layer transfer deciding unit for deciding whether or not a lower layer is transferred; a valid layer deciding unit for deciding the validity and invalidity of a plurality of layers on the basis of a lower layer transfer deciding flag set by the lower layer transfer deciding unit and parameters of the plurality of layers; a layer reading unit for reading only valid layers from a layer storing unit in accordance with the decision; and a synthesizing and calculating unit for performing a synthesizing and calculating process only by the valid layers on the basis of a valid layer flag set by the valid layer deciding unit to update the image of the display screen stored in the display screen storing unit.

According to the above-described structure, since whether the layer is valid or invalid can be decided so that lower layer data hidden by an upper layer is not read from a layer accumulating device, unnecessary accesses to the layer accumulating device can be reduced and the performance of an entire system can be improved.

In the present invention, the lower layer transfer deciding unit decides the transfer of the lower layer for each transfer of image data. According to this structure, whether or not the lower layer is hidden by the upper layer is decided for each area, and the lower layer data in the hidden area is not read from the layer accumulating device. Therefore, unnecessary accesses to the layer accumulating device can be reduced and the performance of an entire system can be improved.

Further, a screen synthesizing device of the present invention comprises: a display screen storing unit for storing an image of a display screen; a transmittance storing unit for storing a transmittance; a layer reading unit for reading layers in order from an upper layer to a lower layer; a transmittance updating unit for updating the transmittance after the layers are read to store the transmittance in the transmittance storing unit; a transmittance deciding unit for deciding whether or not the lower layer is more valid than a currently processed layer in accordance with the transmittance stored in the transmittance storing unit; and a synthesizing and calculating unit for synthesizing and calculating the image of the image data of the display screen stored in the display screen storing unit and the layer data of the currently processed layer to update the image data of the display screen stored in the display screen storing unit only when the currently processed layer is valid. When the upper layer is completely overwritten, the lower layer is not read.

According to the above-described structure, since whether the layer is valid or invalid can be decided so that lower layer data hidden by the upper layer is not read from the layer accumulating device, unnecessary accesses to the layer accumulating device can be reduced and the performance of an entire system can be improved.

In the present invention, the transmittance deciding unit decides the transmittance of the layer for each transfer of the image data. According to this structure, whether or not the lower layer is hidden by the upper layer is decided for each area, and the lower layer data in the hidden area is not read from the layer accumulating device. Therefore, unnecessary accesses to the layer accumulating device can be reduced and the performance of an entire system can be improved.

In the present invention, when a color preset in a position lower than a lowermost layer is applied to all the screen as a background color and arranged as a background, the synthesizing and calculating unit synthesizes and calculates the background color as a further lower screen layer without reading the layer data after the synthesizing and calculating unit synthesizes and calculates the lowermost layer. According to this structure, even when the background color is applied to all the screen, unnecessary accesses to the layer accumulating device can be reduced and the performance of an entire system can be improved.

In the present invention, when the color preset in the position lower than the lowermost layer is applied to all the screen as the background color and arranged as the background, if the currently processed layer is the lowermost layer, a synthesizing unit for synthesizing the image or the display screen stored in the display screen storing unit, the lowermost layer and the background color is added to the synthesizing and calculating unit. According to this structure, even when the background color is applied to all the screen, unnecessary accesses to the layer accumulating device can be reduced and the performance of an entire system can be improved.

In the present invention, when the transmittance stored in the transmittance storing unit is smaller than a preset threshold value, the transmittance deciding unit decides the lower layer to be invalid and does not read the lower layer, even if the upper layer is not completely overwritten, that is, the lower layer is valid. According to this structure, even the lower layer that is apparently hardly visually recognized (namely, the transmittance of the upper layer is not 0, however, substantially close to 0) is not read, so that unnecessary accesses to the layer accumulating device can be more reduced and the performance of an entire system can be more improved.

### ADVANTAGE OF THE INVENTION

According to the present invention, unnecessary accesses to a layer accumulating device can be reduced and the performance of an entire system can be improved.

### BRIEF DESCRIPTION OF THE DRAWINGS

FIG. 1 is a diagram showing a schematic structure of a screen synthesizing device in a first embodiment of the present invention.

FIG. 2 is a diagram showing the structure of a layer reading control part and a layer storing part of the screen synthesizing device in the first embodiment of the present invention.

FIG. 3 is a diagram showing the structure of a layer synthesizing and calculating part and the layer storing part of the screen synthesizing device in the first embodiment of the present invention.

FIG. 4 is a diagram showing the structure of the layer reading control part and the layer storing part of the screen synthesizing device in the first embodiment of the present invention (a structural example for separating layer data).

FIG. 5 is a diagram showing the structure of the layer reading control part and the layer storing part of the screen synthesizing device in the first embodiment of the present invention (a structural example for selecting a transmittance previously given to a layer)

FIG. 6 is a diagram showing a schematic structure of a screen synthesizing device in a second embodiment of the present invention.

FIG. 7 is a diagram showing the structure of a synthesizing and calculating part and a transmittance updating part of the screen synthesizing device in the second embodiment of the present invention.

FIG. 8 is a diagram showing the structure of the synthesizing and calculating part and the transmittance updating part of the screen synthesizing device in the second embodiment of the present invention (a structural example obtained when one previously set color is arranged as a background color on an entire display screen).

FIG. 9 is a diagram showing the structure of the synthesizing and calculating part and the transmittance updating part of the screen synthesizing device in the second embodiment of the present invention (a structural example obtained when the product of a background color and the transmittance of a currently processed layer is calculated, and only when the currently processed layer is a lowermost layer, the product is added to a calculated result of an uppermost layer to the lowermost layer).

FIG. 10 is a diagram showing an inner structure of a usual screen synthesizing device.

FIG. 11 is a diagram for explaining the state of a screen display by the usual screen synthesizing device.

### DETAILED DESCRIPTION OF PREFERRED EMBODIMENTS

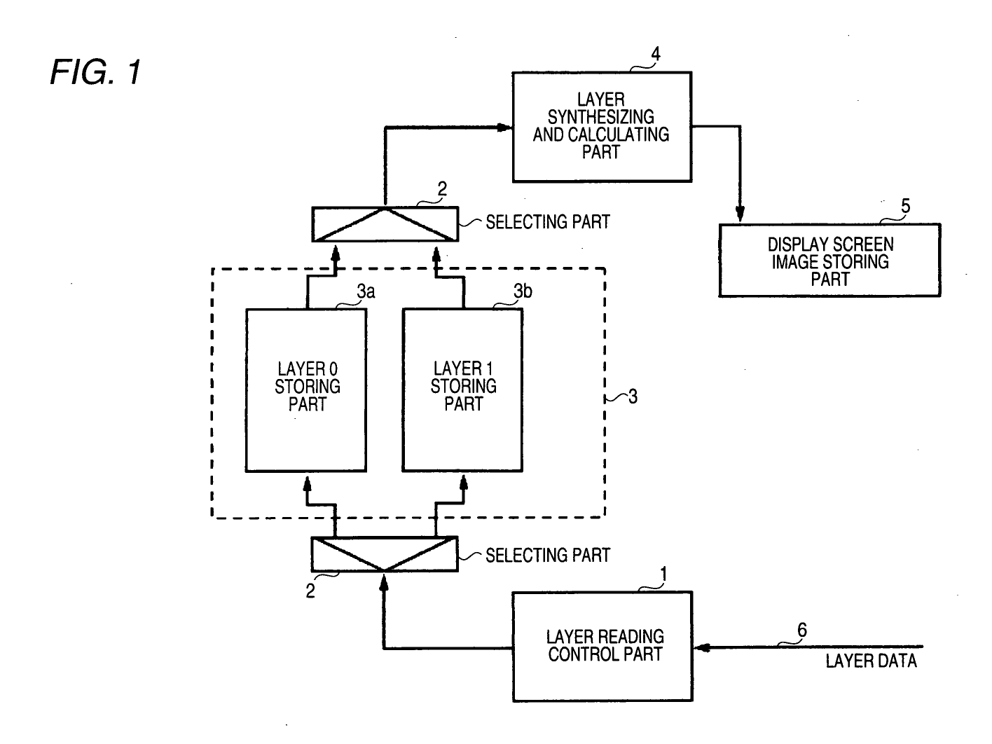

FIG. 1 is a diagram showing a schematic structure of a screen synthesizing device in a first embodiment of the present invention. The screen synthesizing device includes a layer reading control part 1, a selecting part 2, a layer storing part 3, a layer synthesizing and calculating part 4 and a display screen image storing part 5.

The layer reading control part 1 reads layer data from a layer accumulating device that is not shown in the drawing. The layer storing part 3 temporarily stores a layer read in the layer reading part 1. As shown in FIG. 1, the layer storing part 3 includes a plurality of storing parts. The layer synthesizing and calculating part 4 reads the layers temporarily stored in the layer storing part 3 to synthesize and calculate the layers. The display screen image storing part 5 stores the synthesized result. Further, the selecting part 2 exclusively controls the layer reading control part 1 and the layer synthesizing and calculating part 4 not to access the same layer storing part.

For instance, when the layer reading control part 1 accesses a layer 0 storing part 3a, the layer synthesizing and calculating part 4 accesses a layer 1 storing part 3b. When the layer reading control part 1 accesses the layer 1 storing part 3b, the layer synthesizing and calculating part 4 accesses the layer 0 storing part 3a. Such a control is carried out so that the layer reading control part 1 can continuously read the layers and transmit the layers to the layer storing part 3. Accordingly, a processing efficiency can be more improved than that of a usual layer synthesizing and calculating process.

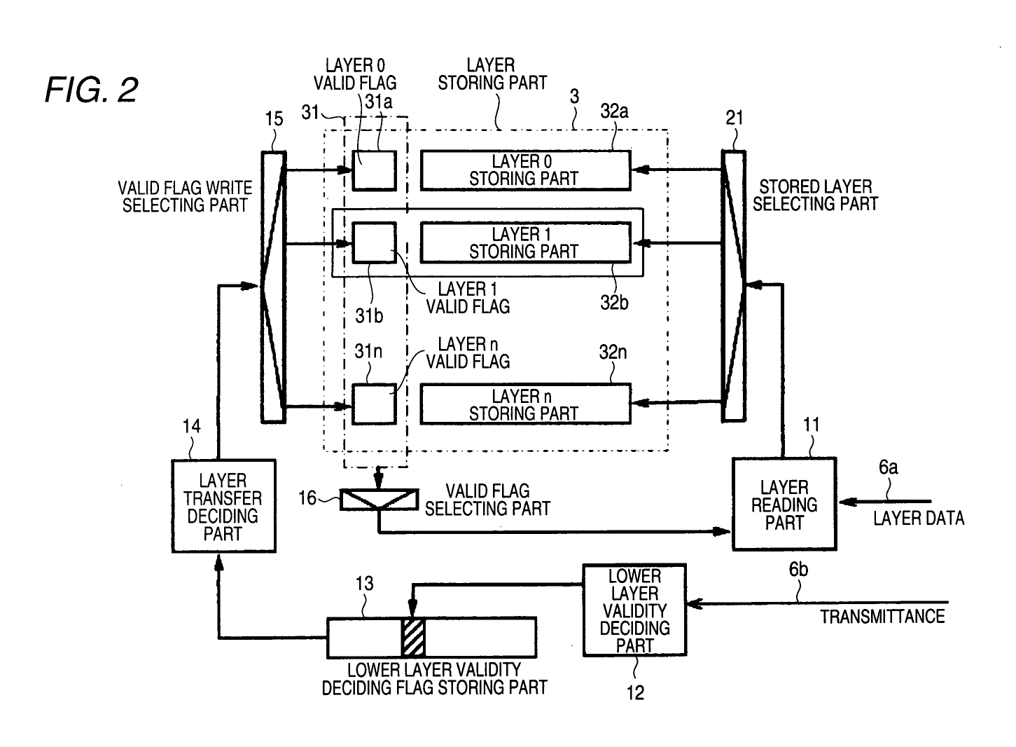

FIG. 2 is a diagram showing the structure of the layer reading control part and the layer storing part of the screen synthesizing device in the first embodiment of the present invention. The layer reading control part 1 includes a layer reading part 11, a lower layer validity deciding part 12, a lower layer validity deciding flag storing part 13, a layer transfer deciding part 14, a valid flag write selecting part 15 and a valid flag selecting part 16. The layer storing part 3 has storing parts respectively corresponding to layers, that is, a layer 0 storing part 32a to a layer n storing part 32n and layer valid flags 31 are respectively set to the storing parts. When the number of the layers that can be displayed at most is 4, the number n of the layer storing parts may be 4.

The layer reading part 11 is connected to the layer storing part 3 through a stored layer selecting part 21 to transfer the read layer data. The valid flag selecting part 16 inputs valid flags to all the layers 0 to n to control the layer reading part 11 to read the data.

Further, the lower layer validity deciding part 12, the lower layer validity deciding flag storing part 13 and the layer transfer deciding part 14 decide a transmittance. The prescribed layer storing part 32 is connected to the layer reading part 11 through the stored layer selecting part 21. Further, the prescribed layer valid flag 31 is connected to the layer transfer deciding part 14 through the valid flag write selecting part 15.

The layer reading part 11 decides whether the layers are valid or invalid in order from an uppermost layer to a lowermost layer in accordance with previously given parameters. When there is a valid layer, the layer reading part 11 reads a prescribed quantity of data related to the layer from a prescribed address of the layer accumulating device.

On the other hand, when there is an invalid layer, the layer transfer deciding part 14 sets a parameter showing invalidity to the layer valid flag 31 of the layer. As a quantity of data to be read, for instance, a quantity of data that can be transferred at a time by a system may be previously determined.

The stored layer selecting part 21 connects the layer storing part 32 related to a currently read layer to the layer reading part 11. The layer reading part 11 transfers the read data to the corresponding layer storing part 32. The data to be stored may include pixel values and transmittance respectively corresponding to pixels.

Further, the layer reading part 11 transfers pixel data. At the same time, the lower layer validity deciding part 12 reads respectively the transmittance of the transferred pixels. When there is a non-transparent pixel, the lower layer validity deciding part 12 sets the value of a corresponding address of the lower layer validity deciding flag storing part 13 to invalidity. For instance when the layer reading part 11 reads 16 pixels and a 13th pixel is a non-transparent pixel, the lower layer validity deciding part 12 sets invalidity to a 13th bit of the lower layer validity deciding flag storing part 13.

The lower layer validity deciding part 12 performs a deciding process to all data read by the layer reading part 11. As a result, when all the bits of the lower layer validity deciding flag storing part 13 are set to invalidity, a layer that is currently processed is decided to be non-transparent Then, the layer transfer deciding part 14 sets the layer valid flags 31 of all the layers located at positions lower than the currently processed layer to invalidity and the layer reading part 11 finishes the reading operations of the layers.

On the other hand, when even one bit of the flags of the lower layer validity deciding flag storing part 13 is set to validity, the currently processed layer is transparent. Accordingly, the layer transfer deciding part 14 does not change all the valid flags of the lower layers. Subsequently, the layers that are located at positions lower than the currently processed layer and valid are likewise read and the layer reading part repeats a reading operation until the layer reading part reaches the lowermost layer or the non-transparent layer appears as described above.

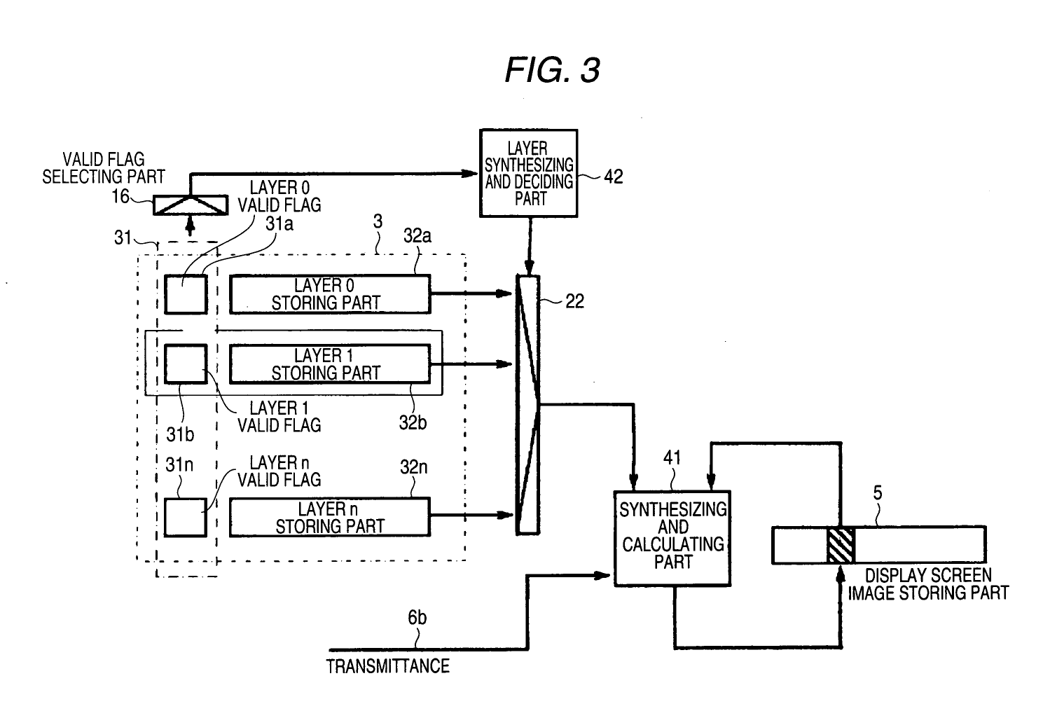

The layer synthesizing and calculating part 4 is connected to the layer storing part 3 through the selecting part 2 like the layer reading control part 1. FIG. 3 is a diagram showing a detailed structure of the layer synthesizing and calculating part and the layer storing part of the screen synthesizing device in the first embodiment of the present invention. The layer synthesizing and calculating part 4 mainly includes a synthesizing and calculating part 41 and a layer synthesizing and deciding part 42. The synthesizing and calculating part 41 performs a synthesizing and calculating process on the basis of pixel data obtained from the display screen image storing part 5, pixel data obtained from the layer storing part 3 and transmittance information and writes and returns a calculated result on the display screen image storing part 5. Here, the valid flag selecting part 16 is a selecting part for connecting one prescribed layer valid flag among all the layer valid flags from a layer 0 valid flag 31a to a layer n valid flag 31n to the layer synthesizing and deciding part 42.

The layer synthesizing and calculating part 4 receives a reading completion signal from the layer reading control part 1 to start the synthesizing and calculating process. Here, as an example, a case that the synthesized calculation result of the layer 0 to the layer n−1 and the layer n are synthesized and calculated will be described. At this time, the synthesized results of the layer 0 to the layer n−1 are already stored in the display screen image storing part 5. The layer synthesizing and deciding part 42 reads the layer n valid flag 31n through the valid flag selecting part 16. When the layer n is set to validity, the layer synthesizing and deciding part 42 controls a selecting part 22 to connect the layer n storing part 32n to the synthesizing and calculating part 41.

The synthesizing and calculating part 41 reads the synthesized results of the layer 0 to the layer n−1 stored in the display screen image storing part 5. Further, the synthesizing and calculating part 41 reads the pixel data of the layer n from the layer n storing part 32n through the selecting part 22, performs a synthesizing calculation in accordance with inputted transmittance and stores a result in the display screen image storing part 5. On the other hand, when the layer n is set to invalidity, the layer synthesizing and deciding part 42 reads the valid flag 31n+1 of a layer n+1 as a next layer through the valid flag selecting part 16 to decide whether the layer is valid or invalid. When the layer is invalid, the layer synthesizing and deciding part 42 reads the layer valid flag 31 of a further subsequent layer. When the layer is valid, the synthesizing and calculating process is carried out in the same procedure as described above.

The above-described processes are performed in order from the layer 0 to the uppermost layer to complete the synthesizing and calculating process. The synthesizing and calculating process is sequentially performed one pixel by one pixel among pixels stored in the layer storing part 3 in order of the lower layer to the upper layer. When the layer synthesizing calculation is completed relative to all the pixels stored in the layer storing part 3, the layer synthesizing and calculating part 4 informs the layer reading control part 1 of the completion of the synthesizing and calculating process.

As described above, while a layer reading process and the synthesizing and calculating process are switched to each other, a display screen is sequentially scanned in a horizontal direction and a vertical direction so that the layers are synthesized on all the display screen. The layer storing part 3 is doubled so that the layer reading process and the synthesizing and calculating process can be performed in parallel to improve the performance of a system.

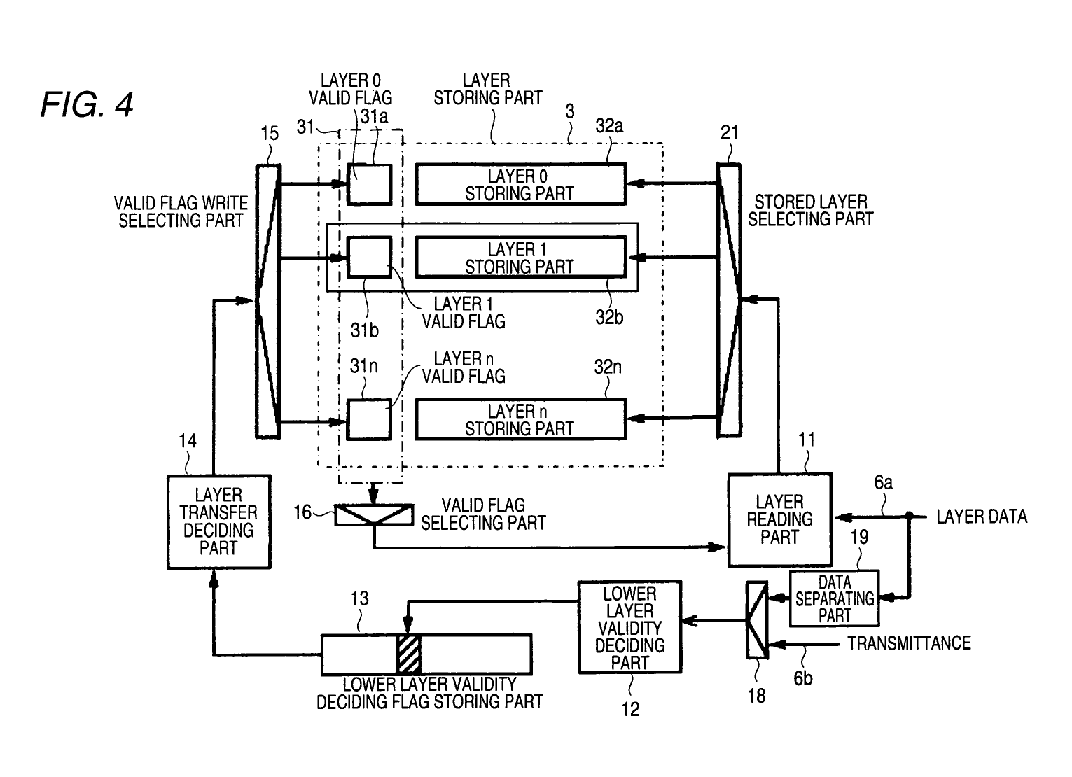

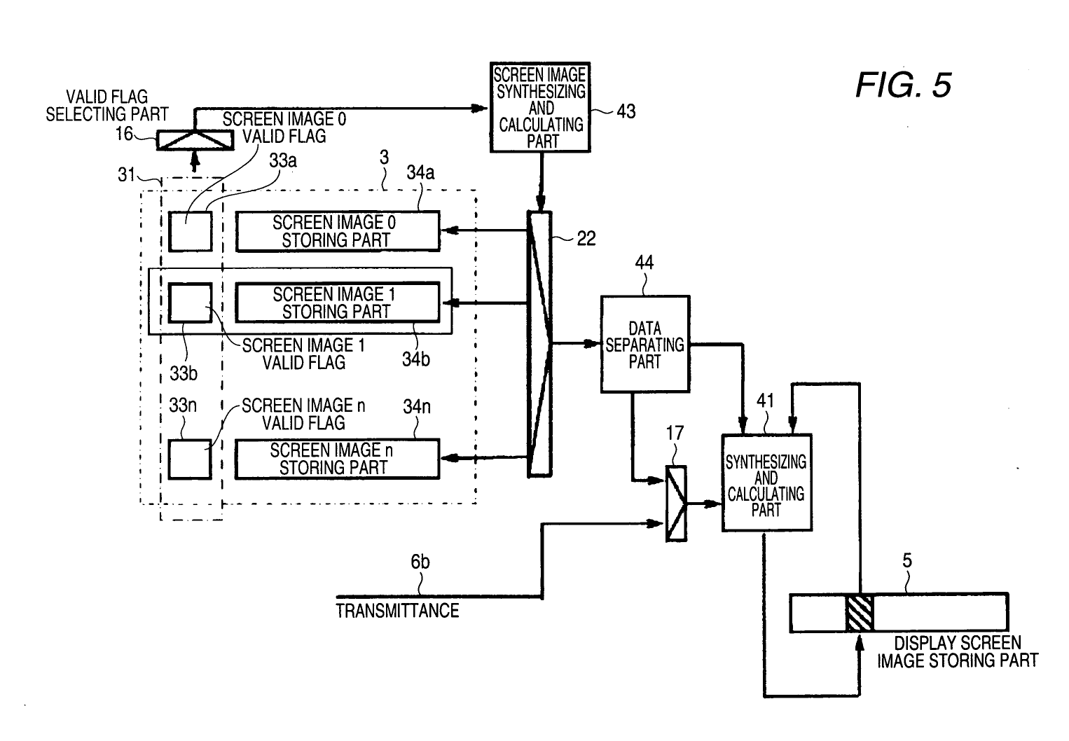

Since the transmittance may be previously given to each layer and the transmittance may be included respectively in the pixels of the layer data, a structure for separating the layer data as shown in FIG. 4 or a structure for selecting the transmittance previously given to the layer as shown in FIG. 5 may be employed.

Further, a quantity of data read at a time by the layer reading control part 1 is variable. For instance, the quantity of data to be read at a time is changed in accordance with the quantity of data to be transferred at a time by the system, so that the performance can be improved. At this time, the layer storing part 3 may have a capacity same as the maximum quantity of data that can be transferred at a time by the system.

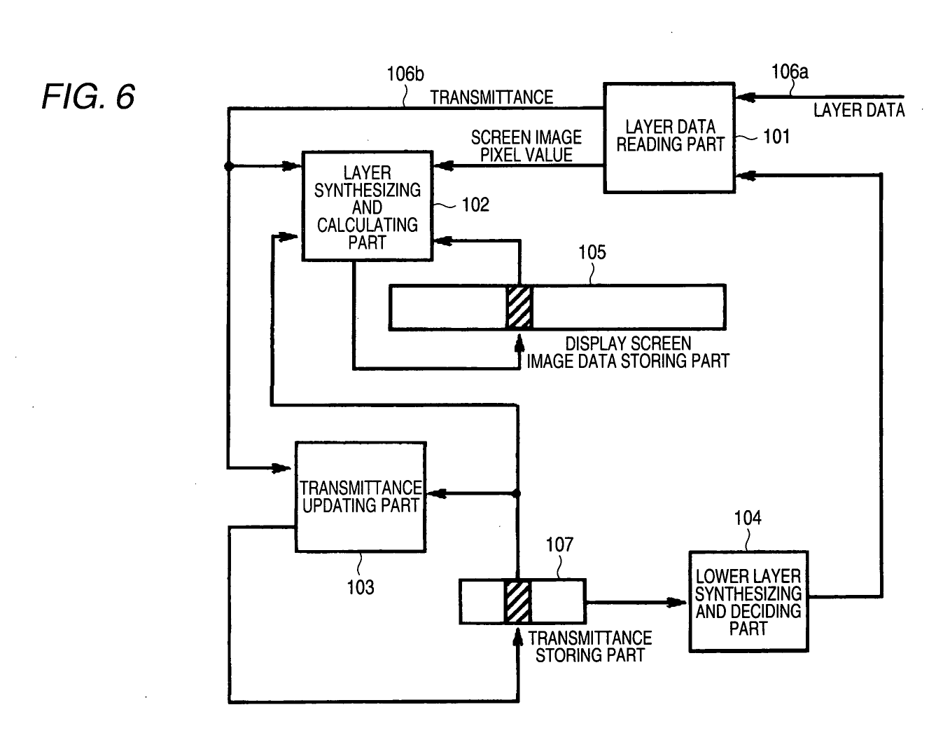

FIG. 6 is a diagram showing a schematic structure of a screen synthesizing device in a second embodiment of the present invention. The screen synthesizing device mainly includes a layer data reading part 101, a layer synthesizing and calculating part 102, a transmittance updating part 103, a lower layer synthesizing and deciding part 104, a display screen data storing part 105 and a transmittance storing part 107.

The layer data reading part 101 reads prescribed layer data and a transmittance from a plurality of layers stored in a system. At this time, when a lower layer is valid in accordance with a deciding signal from the lower layer synthesizing and deciding part 104, the layer data and the transmittance are read. However, when the lower layer is invalid, a relevant layer is inhibited from being read.

The layer synthesizing and calculating part 102 performs a synthesizing and calculating process from display data stored in a prescribed address of the display screen data storing part 105, the layer data, transmittance data stored in a prescribed address of the transmittance storing part 107 and the transmittance of a current layer and stores a result in the prescribed address of the display screen data storing part 105.

The transmittance updating part 103 performs a transmittance updating calculation from the transmittance data stored in the prescribed address of the transmittance storing part 107 and the transmittance of the current layer and stores a result in the transmittance storing part 107.

The lower layer synthesizing and deciding part 104 decides whether the lower layer is valid or invalid from the transmittance data stored in the transmittance storing part 107 and informs the layer data reading part 101 of a result.

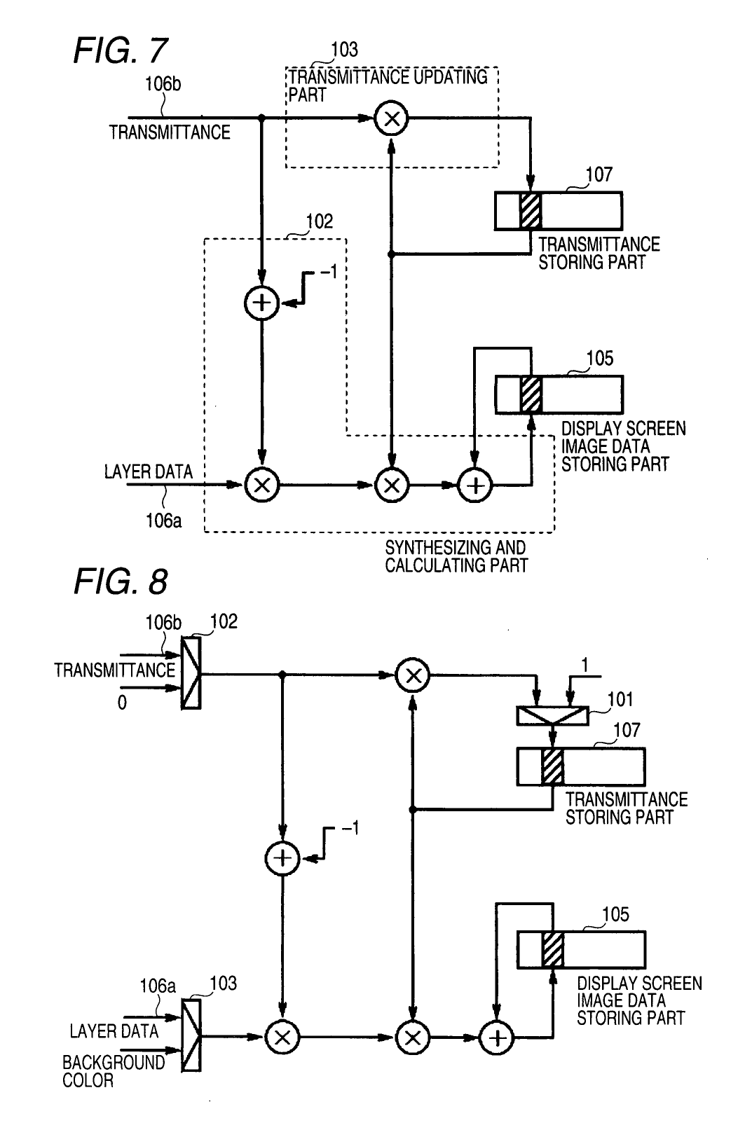

The screen synthesizing device reads pixel data in order from an uppermost layer to a lowermost layer and carries out a synthesizing and calculating process. FIG. 7 is a diagram showing a detailed structure of the synthesizing and calculating part and the transmittance updating part of the screen synthesizing device in the second embodiment of the present invention. Here, as an example, a case will be described that the synthesizing and calculating process of the uppermost layer to a layer n is completed and a layer reading device reads the pixel data of a layer n−1 to perform the synthesizing and calculating process.

In the display screen data storing part 105, a result Sn of the synthesizing calculation of the uppermost layer to the layer n is already stored. In the transmittance storing part 107, a transmittance updated result Cn of the uppermost layer to the layer n is already stored. Here, it is assumed that when the transmittance is 0, the upper layer is completely overwritten, and when the transmittance is 1, the upper layer is completely transparent. When the synthesizing calculation of uppermost layer to the layer n is completed, all the transmittance stored in the transmittance storing part 107 is “0”, the lower layer synthesizing and deciding part decides that the synthesizing process is completed to start a synthesizing process from the uppermost layer of next data.

On the other hand, when even one bit of the transmittance stored in the transmittance storing part 107 is not “0”, the lower layer synthesizing and deciding part 104 instructs the layer data reading part 101 to read the lower layer. Here, when the layer n−1 is valid, the layer data reading part 101 reads the relevant pixel data of the layer n−1 from the system. At this time, it is assumed that the pixel value of the layer n−1 is Aₙ₋₁ and transmittance is αₙ. The layer synthesizing and calculating part 102 calculates a synthesized result Sₙ₋₁ from the uppermost layer to the layer n−1 in accordance with a below-described formula on the basis of the synthesized result Sn of the uppermost layer to the layer n, the pixel value Aₙ₋₁ of the layer n−1, the transmittance αₙ₋₁ of the layer n−1, the result Cn of the transmittance updating calculation of the uppermost layer to the layer n stored in the transmittance storing part 107.
Sₙ₋₁=Sₙ+(1−αₙ₋₁)×Cn×Aₙ₋₁ (Mathematical formula 1)

Further, the transmittance updating part 103 performs a transmittance updating calculation of the uppermost layer to the layer n−1 in accordance with a below-described formula on the basis of the result Cn of the updating calculation of the uppermost layer to the layer n and the transmittance αₙ₋₁ of the layer n−1 and stores a result Cₙ₋₁ in the transmittance storing part 107.
Cₙ₋₁=αₙ₋₁×Cn (Mathematical Formula 2)

The above-described processes are sequentially carried out from the uppermost layer to the lowermost layer to synthesize the layers.

In the screen synthesizing device of the second embodiment similarly to the synthesizing device of the first embodiment, a quantity of data read at a time by a layer reading device is variable. For instance, the quantity of data to be read at a time is changed in accordance with the quantity of data to be transferred at a time by the system, so that the performance can be improved. At this time, a layer storing device may have a capacity same as the maximum quantity of data that can be transferred at a time by the system.

Further, when a previously set one color is arranged as a background color in a layer lower than the lowermost layer on all the display screen, the structure of the layer synthesizing and calculating part 102 and the transmittance updating part 103 in FIG. 7 maybe replaced by a structure shown in FIG. 8 in which after the synthesizing and calculating process of an uppermost layer to a lowermost layer is completed, a synthesizing calculation is carried out to the synthesized and calculated result of the uppermost layer to the lowermost layer and the background color.

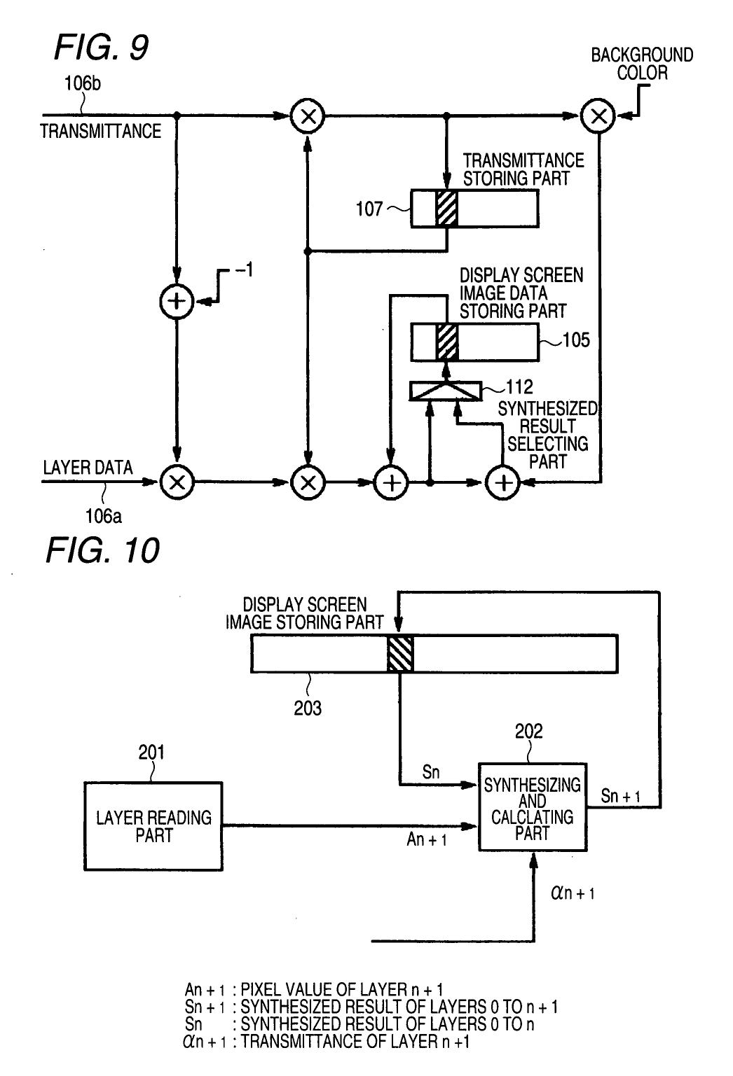

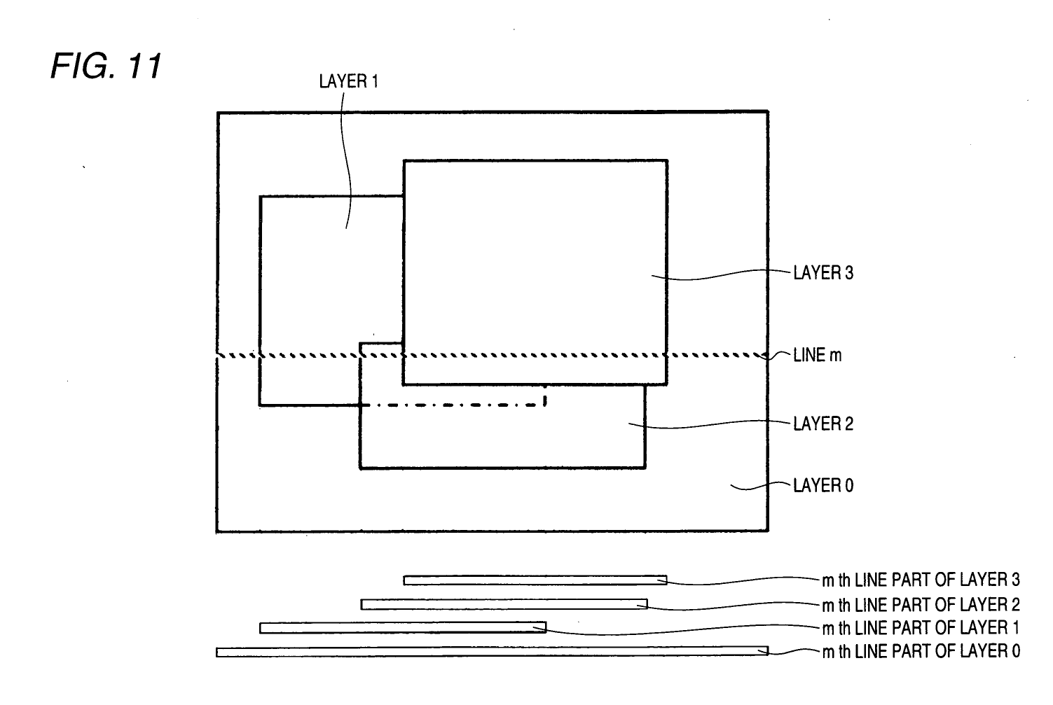

Further, a structure shown in FIG. 9 may be employed in which the product of a background color and the transmittance of a currently processed layer is calculated, and only when the currently processed layer is a lower most layer, the product is added to the calculated result of an uppermost layer to a lowermost layer so that when the lowermost layer is synthesized and calculated, the synthesized calculation of the background color and the synthesized result can be performed at the same time. Thus, the speed of a synthesizing and calculating process can be improved. In this case, since the product of the background layer and the transmittance of the lowermost layer is obtained and the product is added to the synthesized result, it is not necessary to decide whether or not the lowermost layer is overwritten.

In the above-description, when all the transmittance stored in the transmittance storing part 107 is “0”, the lower layer synthesizing and deciding part 104 decides that the layer is overwritten to complete the synthesizing process of the layers. However, to achieve the synthesizing and calculating process at higher speed, a prescribed threshold value may be determined, and when the transmittance stored in the transmittance storing part 107 is not higher than the threshold value, the layer may be decided to be overwritten. As described above, the product of the pixel vale of the lower layer and the transmittance stored in the transmittance storing part 107 is added to the synthesized and calculated result of the lower layer to the upper layer to update the synthesized and calculated result. Therefore, when the transmittance is sufficiently small, a difference hardly arises between the synthesized result before updating and the synthesized result after updating. Accordingly, the above-described threshold value is set to a sufficiently small value, so that accesses to the layer accumulating device can be more decreased and the display screen can be maintained so that the difference is apparently hardly recognized.

The screen synthesizing device of the present invention has effects that unnecessary accesses to the layer accumulating device can be reduced and the performance of the entire system can be improved and is useful in the screen synthesizing process for laminating the plurality of layers.

What is claimed is:

1. A screen synthesizing device comprising:
a display screen storing unit for storing an image of a display screen;
a lower layer transfer deciding unit for deciding whether or not a lower layer is transferred;
a valid layer deciding unit for deciding the validity and invalidity of a plurality of layers on the basis of a lower layer transfer deciding flag set by the lower layer transfer deciding unit and parameters of the plurality of layers;
a layer reading unit for reading only valid layers from a layer storing unit in accordance with the decision; and
a synthesizing and calculating unit for performing a synthesizing and calculating process only by the valid layers on the basis of a valid layer flag set by the valid layer deciding unit to update the image of the display screen stored in the display screen storing unit.

2. A screen synthesizing device according to claim 1, wherein the lower layer transfer deciding unit decides the transfer of the lower layer for each transfer of image data.

3. A screen synthesizing device comprising:
a display screen storing unit for storing an image of a display screen;
a transmittance storing unit for storing a transmittance;
a layer reading unit for reading layers in order from an upper layer to a lower layer;
a transmittance updating unit for updating the transmittance after the layers are read to store the transmittance in the transmittance storing unit;
a transmittance deciding unit for deciding whether or not the lower layer is more valid than a currently processed layer in accordance with the transmittance stored in the transmittance storing unit; and
a synthesizing and calculating unit for synthesizing and calculating the image of the image data of the display screen stored in the display screen storing unit and the layer data of the currently processed layer to update the image data of the display screen stored in the display screen storing unit-only when the currently processed layer is valid.

4. A screen synthesizing device according to claim 3, wherein the transmittance deciding unit decides the transmittance of the layer for each transfer of the image data.

5. A screen synthesizing device according to claim 3, wherein the synthesizing and calculating unit synthesizes and calculates a back ground color as a further lower screen layer without reading the layer data after the synthesizing and calculating unit synthesizes and calculates the lowest layer.

6. A screen synthesizing device according to claim 3, wherein the synthesizing and calculating unit includes a synthesizing unit for synthesizing the image of the display screen stored in the display screen storing unit, the lowest layer and the background color when the currently processed layer is the lowest layer.

7. A screen synthesizing device according to claim 3, wherein the transmittance deciding unit decides the lower layer to be invalid even when the lower layer is valid if the transmittance stored in the transmittance storing unit is lower than a preset threshold value.
